(19) United States
(12) Patent Application Publication
(10) Pub. No.: US 2015/0268751 A1
(43) Pub. Date: Sep. 24, 2015

(54) TOUCH DEVICE HAVING TOUCH PANEL AND SCANNING METHOD OF THE TOUCH PANEL

(71) Applicants: INTERFACE OPTOELECTRONIC (SHENZHEN) CO., LTD., Shenzhen (CN); GENERAL INTERFACE SOLUTION LIMITED, Miaoli County (TW)

(72) Inventors: CHIA-YUAN WU, Hsinchu (TW); CHUN-HUNG HUANG, Hsinchu (TW)

(21) Appl. No.: 14/555,715

(22) Filed: Nov. 28, 2014

(30) Foreign Application Priority Data
Mar. 21, 2014 (CN) 201410109435.X

(51) Int. Cl. G06F 3/041

(52) U.S. Cl. CPC G06F 3/041

(57) ABSTRACT

A scanning method for a touch panel of a touch device, the touch panel includes a plurality of first electrodes and a plurality of second electrodes isolately intersecting with the first electrodes. At a first period t1, a scanning signal is transmitted to each first electrode, and a first sensing signal output from each second electrode is received at the first period t1 to determine whether or not at least one second electrode is touched. At a second period t2, the scanning signal is transmitted to the at least one second electrode and one or more other second electrode surrounding the at least one second electrode in turn, and a second sensing signal is received from each first electrode to locate at least one touch operation applied on the touch panel.

### CROSS-REFERENCE TO RELTATED APPLICATIONS

This application claims priority to Chinese Patent Application No. 201410109435.X filed on Mar. 21, 2014 in the Chinese Intellectual Property Office, the contents of which are incorporated by reference herein.

### FIELD

Embodiments of the present disclosure generally relate to a touch device, and more particularly, to a touch device having a touch panel and a scanning method of the touch panel.

### BACKGROUND

Capacitive touch panels such as mutual capacitive touch panels are widely used in various touch devices, such as smart phones and tablet computers.

### BRIEF DESCRIPTION OF THE DRAWINGS

Implementations of the present technology will now be described, by way of example only, with reference to the attached figures.

FIG. 1 is an equivalent circuit diagram of a touch panel of a touch device.

FIG. 2 shows a schematic diagrams of the touch panel including a plurality of first electrodes and a plurality of sensing electrodes.

FIG. 3 shows a block diagram of a scanning controller of FIG. 1.

FIG. 4 is a flowchart diagram of one embodiment of a scanning method of the touch panel of FIG. 1.

FIG. 5 is a wave form of a plurality first scanning signals applied to each of the first electrodes at a first period t1.

FIG. 6 shows a touch point applied on the touch panel.

FIG. 7 is a wave form of a plurality of second scanning signals applied to some of the second electrodes in a determined region at a second period t2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The word “unit,” as used herein, refers to logic embodied in hardware or firmware, or to a collection of software instructions, written in a programming language, such as, Java, C, or assembly. One or more software instructions in the units may be embedded in firmware, such as in an erasable programmable read only memory (EPROM). The units described herein may be implemented as either software and/or hardware units and may be stored in any type of non-transitory computer-readable medium or other storage devices. Some non-limiting examples of non-transitory computer-readable medium include CDs, DVDs, BLU-RAY, flash memory, and hard disk drives.

The present disclosure is described in relation to a scanning method for a touch panel of a touch device.

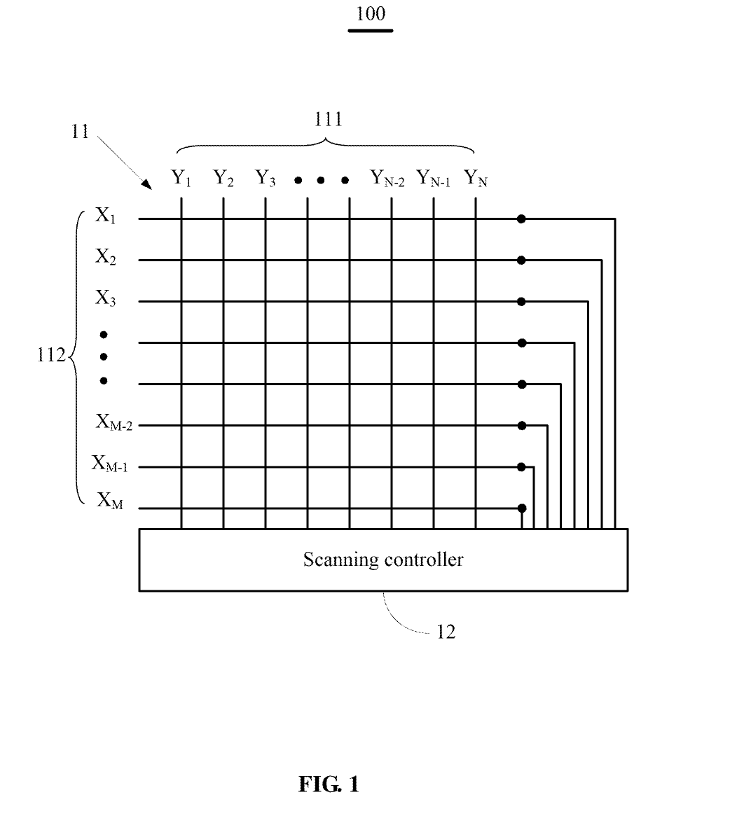

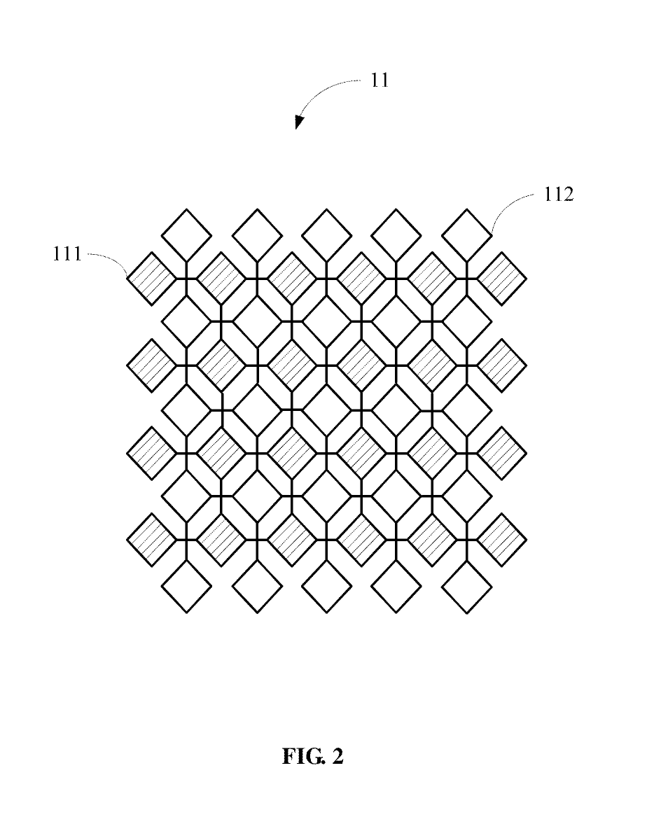

FIG. 1 and FIG. 2 illustrate a touch device 100 of the embodiment. The touch device 100 includes a touch panel 11 and a scanning controller 12. The touch panel 11 includes a plurality of first electrodes 111 and a plurality of second electrodes 112 isolately intersecting with the first electrodes 111 to form a touch sensor of the touch panel 11 for sensing touch operations. The plurality of first electrodes 111 extend along a first orientation, and the plurality of second electrodes 112 extend along a second orientation intersecting with the first orientation. In this embodiment, the plurality of first electrodes 111 are respectively represented by X₁, X₂, X₃ . . . X_{N-2}, X_{N-2}, X_{N}, and the plurality of second electrodes 112 are respectively represented by Y₁, Y₂, Y₃ . . . Y_{M-2}, Y_{M-2}, Y_{M}, wherein N represents a total number of the first electrodes and M represents a total number of the second electrodes.

The scanning controller 12 is electrically coupled to both the plurality of first electrodes 111 and the plurality of second electrodes 112 to scan the touch panel 11. The scanning controller 12 generates scanning signals and transmits the scanning signals to the first electrodes 111 and the second electrodes 112 to locate touch operations applied on the touch panel 11. In this embodiment, when the first electrodes 111 serve as scanning electrodes of the touch panel, the second electrodes 112 will serve as sensing electrodes to output sensing signals when the first electrodes 111 are scanned. When the second electrodes 112 serve as the scanning electrodes of the touch panel, the first electrodes 111 will serve as the sensing electrodes to output sensing signals when the second electrodes 112 are scanned. The scanning controller 12 can locate the touch operations on the touch panel 11 according to the sensing signals output from the sensing electrodes.

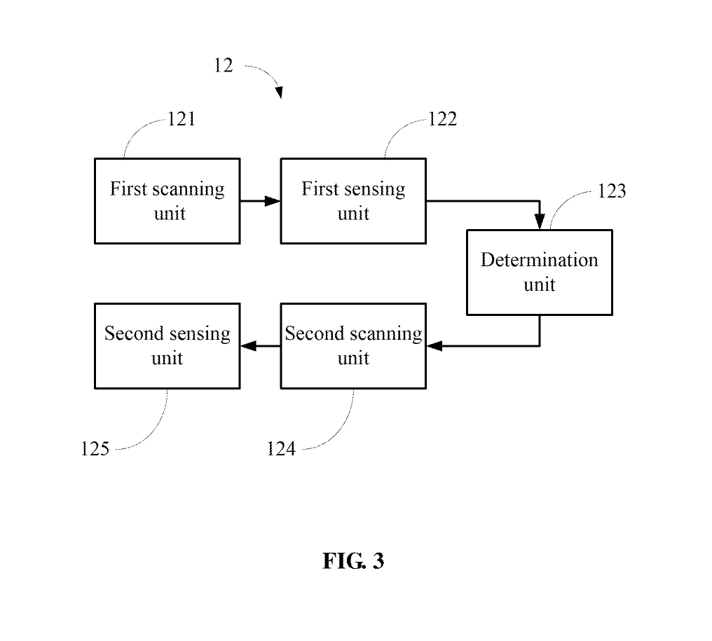

FIG. 3 illustrates that the scanning controller 12 includes a first scanning unit 121, a first sensing unit 122, a determination unit 123, a second scanning unit 124, and a second sensing unit 125. In at least one embodiment, the first scanning unit 121, the first sensing unit 122, the determination unit 123, the second scanning unit 124, and the second sensing unit 125 can be coupled with each other for data exchange. Details of the units of the scanning controller 12 are described below.

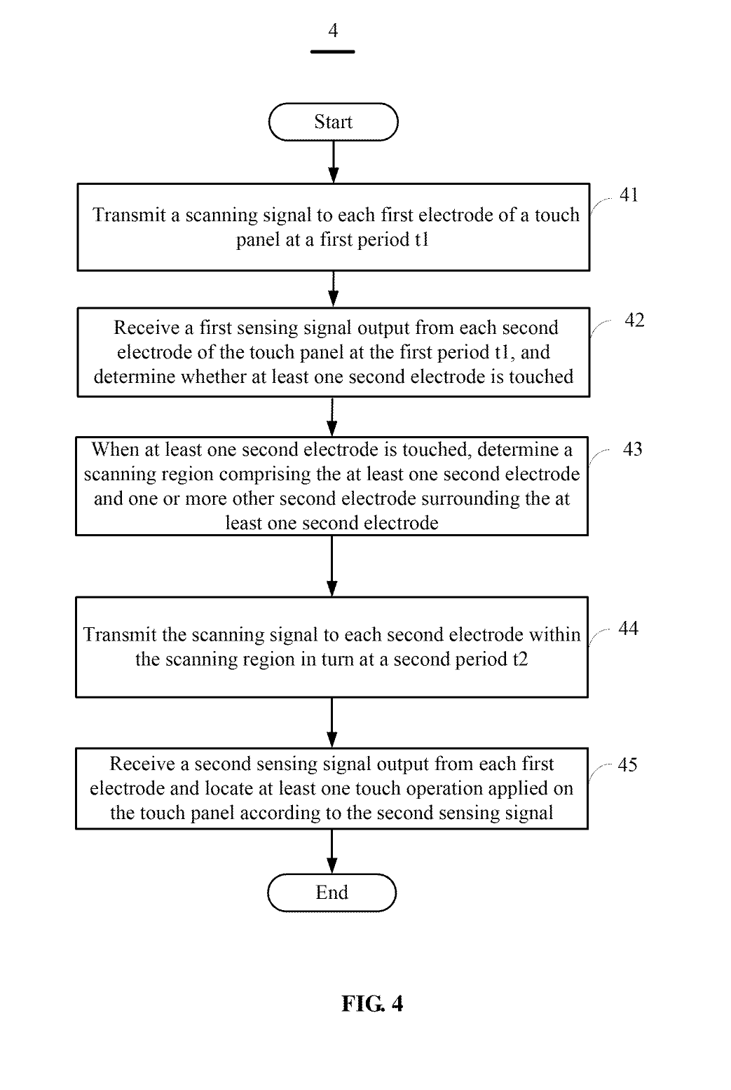

FIG. 4 illustrates a flowchart of an example method 4 of the disclosure. The method 4 is provided by way of example, as there are a variety of ways to carry out the method 4. The method 4 described below can be carried out using the functional units of the scanning controller 12 as illustrated in FIG. 3, for example, and various elements of this figure are referenced in explaining the example method 4. Each block shown in FIG. 4 represents one or more processes, methods, or subroutines which are carried out in the example method 4. Furthermore, the order of blocks is illustrative only and the order of the blocks can change. Additional blocks can be added or fewer blocks may be utilized without departing from the scope of this disclosure. The example method 4 can begin at block 41.

At block 41, the first scanning unit 121 transmits a scanning signal to each first electrode 111 and scan each first electrode 111 for a first period t1. At the first period t1, each first electrode 111 serves as the scanning electrode of the touch panel 11, and each second electrode 112 servers as the sensing electrode of the touch panel 11 and outputs a first sensing signal.

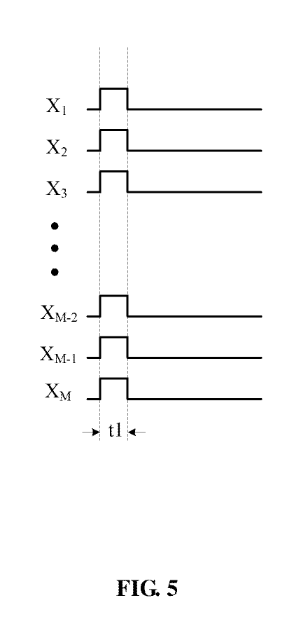

As shown in FIG. 5, an example of the scanning signal transmitted to each of the first electrodes X₁, X₂, X₃ . . . X_{N-2}, X_{N-2}, X_{N} including at least one high voltage pulse signal is shown. In at least one embodiment, the scanning signal is simultaneously transmitted to each of the first electrodes X₁, X₂, X₃ . . . X_{N-2}, X_{N-2}, X_{N}.

At block 42, the first sensing unit 122 receives the sensing signal outputted from each second electrode 112 at the first period t1, and determines whether or not at least one second electrode 112 is touched.

At block 43, when at least one second electrode 112 is touched, the determination module 123 determines a scanning region including at least one second electrode 112 and one or more other second electrodes 112 surrounding the at least one second electrode 112.

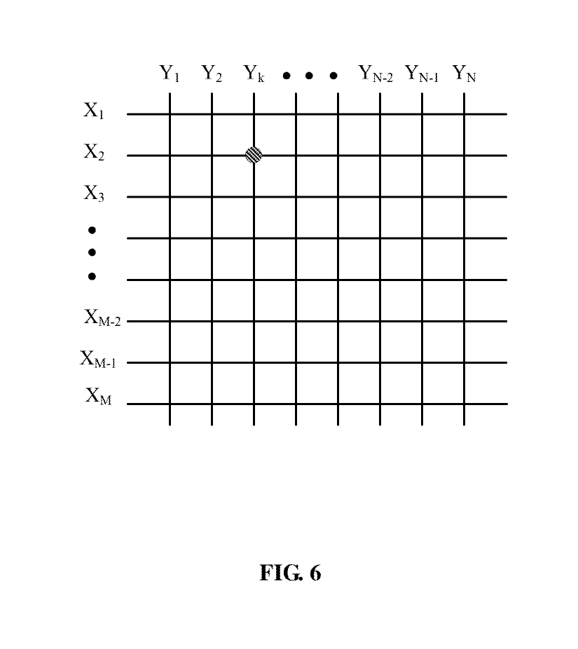

In one example, as shown in FIG. 6, if the second electrode Yₖ is determined to have been touched by the first sensing unit 122, the scanning region includes at least two second electrodes which are represented by Yₖ₋ₐ, . . . Yₖ, . . . , Yₖ₊ₐ, wherein “a” is a predetermined constant. In at least one embodiment, the constant “a” is less than or equal to three. In the embodiment, if the result of “k” minus “a” (hereinafter “k−a”) is less than one, k−a will be set to one. That is the second electrode Yₖ₋ₐ will be substituted by the second electrode Y₁. If the result of “k” plus “a” (hereinafter “k+a”) is greater than the total number (M) of the second electrodes 112, “k+a” will be set to the total number of the second electrodes 112. That is, the second electrode Yₖ₊ₐ will be substituted by the second electrode Y_{M}.

At block 44, the second scanning unit 124 transmits the scanning signal to each second electrode 112 within the scanning region in turn at the second period t2.

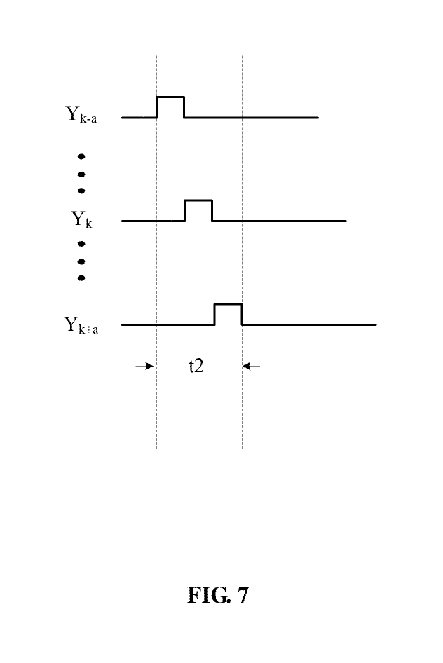

At the second period t2, each second electrode 112 within the scanning region serves as the scanning electrode of the touch panel 11, and each first electrode 111 servers as the sensing electrode of the touch panel 11 and outputs a second sensing signal. For example, FIG. 7 illustrates that the scanning signal which includes at least one high voltage pulse signal is transmitted to each second electrode 112 within the scanning range [Yₖ₋ₐ, Yₖ₊ₐ] in turn by the second scanning unit 124.

At block 45, the second sensing unit 125 receives the second sensing signal outputted from each first electrode 111 and locates at least one touch operation applied on the touch panel 11 according to the second sensing signal.

For example, FIG. 6 illustrates when the scanning signal is transmitted to the second electrode Yₖ, the first electrode X₂ is determined to have been touched according the second sensing signal outputted from the first electrode X₂. Then, the touch operation is located at an intersection point (X₂, Yₖ) of the first electrode X₂ and the second electrode Yₖ.

As described above, if the touch panel 11 includes one hundred of first electrodes and one hundred of second electrodes, the above mentioned scanning method of the touch panel 11 may need at most a total of “1+10×(2a+1) ” scanning times to scan the first and second electrodes to locate a touch position. At the condition that the constant “a” is set to the maximum number (e.g., three), the above mentioned scanning method only needs eight scanning times to locate the touch operation. However, the traditional scanning method may need at least one hundred scanning times to locate the touch operation when the touch panel 11 includes the total of one hundred of first electrodes and one hundred of second electrodes. That is, the scanning method of the present disclosure can greatly decrease the scanning time of the touch panel 11.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A touch device comprising:
a touch panel comprising a plurality of first electrodes and a plurality of second electrodes isolately intersecting with the first electrodes; and
a scanning controller comprising:
a first scanning unit transmitting a scanning signal to each first electrode at a first period t1;
a first sensing unit receiving a first sensing signal output from each second electrode at the first period t1, and determining whether or not at least one second electrode is touched;
a determination module determining a scanning region comprising the at least one second electrode and one or more other second electrodes surrounding the at least one second electrode, if the at least one second electrode is touched; and
a second scanning unit transmitting the scanning signal to each second electrode within the scanning region in turn at a second period t2; and
a second sensing unit receiving a second sensing signal output from each first electrode and locating at least one touch operation applied on the touch panel according to the second sensing signal.

2. The touch device according to claim 1, wherein at the first period t1, each first electrode serves as a scanning electrode of the touch panel, and each second electrode servers as a sensing electrode of the touch panel to output the first sensing signal.

3. The touch device according to claim 2, wherein at the second period t2, each second electrode within the scanning region serves as the scanning electrode of the touch panel, and each first electrode servers as the sensing electrode of the touch panel to output the second sensing signal.

4. The touch device according to claim 1, wherein the plurality of second electrodes are respectively represented by Y₁, Y₂, Y₃ . . . Y_{M-2}, Y_{M-2}, Y_{M}, the scanning region comprises at least two second electrodes which are respectively represented by Yₖ₋ₐ, . . . Yₖ, . . . , Yₖ₊ₐ, wherein Yₖ represents the at least one second electrode which is touched, a is a predetermined constant, and M represents a total number of the plurality of second electrodes.

5. The touch device according to claim 4, wherein the constant a is less than or equal to three.

6. The touch device according to claim 4, wherein if a result of “k” minus “a” is less than one, the second electrode Yₖ₋ₐ is substituted by the second electrode Y₁; if a result of “k” plus “a” is greater than M which represents the total number of the second electrodes, the second electrode Yₖ₊ₐ is substituted by the second electrode Y_{M}.

7. A scanning method for a touch panel of a touch device, the touch panel comprising a plurality of first electrodes and a plurality of second electrodes isolately intersecting with the first electrodes, the method comprising:
transmitting a scanning signal to each first electrode at a first period t1;
receiving a first sensing signal output from each second electrode at the first period t1, and determining whether or not at least one second electrode is touched;
determining a scanning region comprising the at least one second electrode and one or more other second electrode surrounding the at least one second electrode, if the at least one second electrode is touched; and
transmitting the scanning signal to each second electrode within the scanning region in turn at a second period t2;
receiving a second sensing signal output from each first electrode; and
locating at least one touch operation applied on the touch panel according to the second sensing signal.

8. The method according to claim 7, wherein at the first period t1, each first electrode serves as a scanning electrode of the touch panel, and each second electrode servers as a sensing electrode of the touch panel to output the first sensing signal.

9. The method according to claim 8, wherein at the second period t2, each second electrode within the scanning region serves as the scanning electrode of the touch panel, and each first electrode servers as the sensing electrode of the touch panel to output the second sensing signal.

10. The method according to claim 7, wherein the plurality of second electrodes are respectively represented by Y₁, Y₂, Y₃ . . . Y_{M-2}, Y_{M-2}, Y_{M}, the scanning region comprises at least two second electrodes which are respectively represented by Yₖ₋ₐ, . . . Yₖ, . . . , Yₖ₊ₐ, wherein Yₖ represents the at least one second electrode which is touched, a is a predetermined constant, and M represents a total number of the plurality of second electrodes.

11. The method according to claim 10, wherein the constant a is less than or equal to three.

12. The method according to claim 10, wherein if a result of “k” minus “a” is less than one, the second electrode Yₖ₋ₐ is substituted by the second electrode Y₁; if a result of “k” plus “a” is greater than M which represents the total number of the second electrodes, the second electrode Yₖ₊ₐ is substituted by the second electrode Y_{M}.
